(19) United States
(12) Patent Application Publication
(10) Pub. No.: US 2007/0253442 A1
(43) Pub. Date: Nov. 1, 2007

(54) Apparatus and method for transmitting/receiving control channel in an orthogonal frequency division multiplexing system

(75) Inventors: Jae-Chon Yu, Suwon-si (JP); Dong-Hee Kim, Yongin-si (JP); Hwan-Joon Kwon, Hwaseong-si (JP); Jin-Kyu Han, Seoul (KR); Yu-Chul Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/728,176

(22) Filed: Mar. 23, 2007

(30) Foreign Application Priority Data
Mar. 25, 2006 (KR) 27219/2006

(51) Int. Cl. H04J 1/00

(52) U.S. Cl. 370/464

(57) ABSTRACT

A transmission/reception method for transmitting a control channel in an Orthogonal Frequency Division Multiplexing (OFDM) system. The transmission method includes generating a plurality of control channels such that control information for demodulation of the plurality of control channels is distributed over information of other control channels; and modulating a data channel and the control channels into a radio signal according to a predetermined transmission scheme, and transmitting the radio signal to a wireless network. The reception method includes receiving a plurality of control channels transmitted via a wireless network; and extracting control information for demodulation of the control channels from other previously received control channels, and performing the demodulation using the control information.

### PRIORITY

This application claims priority under 35 U.S.C. §119(a) to a Korean Patent Application filed in the Korean Intellectual Property Office on Mar. 25, 2006 entitled “Apparatus And Method For Transmitting/Receiving Control Channel In An Orthogonal Frequency Division Multiplexing System” and assigned Serial No. 2006-27219, the disclosure of which is incorporated herein by reference.

### BACKGROUND OF THE INVENTION

1. Field of the Invention

The present invention relates generally to a transmission/reception apparatus and method for a wireless communication system, and in particular, to an apparatus and method for transmitting/receiving control channels in an Orthogonal Frequency Division Multiplexing (OFDM) system.

2. Description of the Related Art

Wireless communication systems have been developed to connect fixed wire networks to mobile terminals. Typical wireless communication systems are mobile communication systems, Wireless Local Area Network (LAN) systems, Wireless Broadband Internet (Wibro) systems, and Mobile Ad Hoc systems.

Mobile communication, unlike the general wireless communication, is premised on mobility of users. The ultimate goal of the mobile communication is to allow the users to exchange information media using terminals such as mobile phone and radio paging receiver, regardless of time and place.

In addition, with the rapid progress of communication technologies using mobile terminals, mobile communication systems have been developed to provide not only the general voice call service but also high-speed data services capable of transmitting high-volume digital data such as moving image as well as e-mail and still image.

An OFDM transmission scheme is one of the typical wireless mobile communication systems employing a multi-carrier transmission scheme, which provides high-speed data services. The OFDM transmission scheme, a scheme for converting a serial input symbol stream into parallel streams and then modulating them with multiple orthogonal subcarriers before transmission, has started to attract attention with the development of Very Large Scale Integration (VLSI) technology since the early 1990s.

The OFDM transmission scheme, as it modulates data using multiple orthogonal subcarriers, shows high robustness against a frequency selective multipath fading channel, compared with the conventional single-carrier modulation scheme, and this transmission scheme is suitable for the high-speed data services such as broadcast services.

The existing OFDM systems have used one control channel. Generally, however, because all users use the control channel, attempts are being made to use multiple control channels in the OFDM system in order to reduce system load. In the following description, it will be assumed that the multiple control channels include a Primary Data Control Channel (PDCCH) and a Secondary Data Control Channel (SDCCH). The SDCCH transmits various control information used for demodulating data channels. The PDCCH transmits control information such as Modulation Coding Scheme (MCS) of the SDCCH, offset information indicating positions of subcarriers, size information of resources, and the like.

FIG. 1 illustrates the transmission structure of a control channel in a forward link of a general OFDM system. The illustrated exemplary transmission structure uses PDCCH and SDCCH as control channels, and groups the SDCCHs.

Mobile terminals are classified into a plurality of groups according to the distance from a base station and/or channel environment. The base station encodes and transmits SDCCHs in association with corresponding groups using MCS that mobile terminals in each group can readily detect. For example, if the number of the groups is 3, SDCCHs can be classified into a first SDCCH (G#1) 101, a second SDCCH (G#2) 103, and a third SDCCH (G#3) 105. Control information for demodulation of the first SDCCH G#1 101, the second SDCCH G#2 103, and the third SDCCH G#3 105 is transmitted to mobile terminals over a PDCCH 107.

Referring to FIG. 1, the first SDCCH 101 is encoded using Quadrature Phase Shift Keying (QPSK) as a modulation scheme and rate-(5,1) convolutional coding (or rate-⅕ convolutional coding) as a coding scheme, for the mobile terminals located in the cell boundary having poor channel environment. The second SDCCH 103 is encoded using 16-ary Quadrature Amplitude Modulation (16 QAM) and rate-(3,1) convolutional coding (or rate-⅓ convolutional coding), for the mobile terminals located between the cell boundary and the cell center. The third SDCCH 105 is encoded using 64 QAM and rate-(2,1) convolutional coding (or rate-½ convolutional coding), for the mobile terminals located in the cell center having the best channel environment. Control information 109, 111 and 113 transmitted over the PDCCH 107 includes control information such as MCS, offset of subcarriers, and size of used resources, for demodulation of the first to third SDCCHs 101, 103 and 105 for the corresponding groups.

The control information for the first to third SDCCHs 101, 103 and 105 is block-coded per group or block-coded at a time, and then inserted into the PDCCH 107 before being transmitted. The control information transmission over the PDCCH, as it groups the SDCCHs, is efficient compared with the use of a single control channel. However, this scheme also inefficiently uses wireless resources because it should transmit control information of all SDCCH groups over one PDCCH.

### SUMMARY OF THE INVENTION

An aspect of the present invention is to address at least the above problems and/or disadvantages and to provide at least the advantages described below. Accordingly, an aspect of the present invention is to provide a control channel transmission/reception apparatus and method capable of efficiently using frequency resources for control channels in an OFDM system.

Another aspect of the present invention is to provide an apparatus and method for efficiently transmitting control information for demodulation of control channels when grouping control channels before transmission in an OFDM system.

According to one aspect of the present invention, there is provided a transmission apparatus for transmitting a control channel in an Orthogonal Frequency Division Multiplexing (OFDM) system. The transmission apparatus includes a transmitter for modulating a data channel and a plurality of control channels into a radio signal according to a predetermined transmission scheme, and transmitting the radio signal to a wireless network; and a control channel processor for controlling an operation of transmitting channel by channel control information for demodulation of each of the control channels over other control channels respectively.

According to another aspect of the present invention, there is provided a transmission method for transmitting a control channel in an Orthogonal Frequency Division Multiplexing (OFDM) system. The transmission method includes generating a plurality of control channels such that control information for demodulation of the plurality of control channels is distributed over information of other control channels respectively; and modulating a data channel and the control channels into a radio signal according to a predetermined transmission scheme, and transmitting the radio signal to a wireless network.

According to a further aspect of the present invention, there is provided a reception apparatus for receiving a control channel in an Orthogonal Frequency Division Multiplexing (OFDM) system. The reception apparatus includes a receiver for receiving a data channel and a plurality of control channels, transmitted via a wireless network, according to a predetermined transmission scheme; and a control channel demodulator for extracting control information for demodulation of the control channels from other previously received control channels respectively, and performing the demodulation using the control information.

According to yet another aspect of the present invention, there is provided a reception method for receiving a control channel in an Orthogonal Frequency Division Multiplexing (OFDM) system. The reception method includes receiving a plurality of control channels transmitted via a wireless network; and extracting control information for demodulation of the control channels from other previously received control channels respectively, and performing the demodulation using the control information.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a transmission structure of a control channel in a forward link of a general OFDM system;

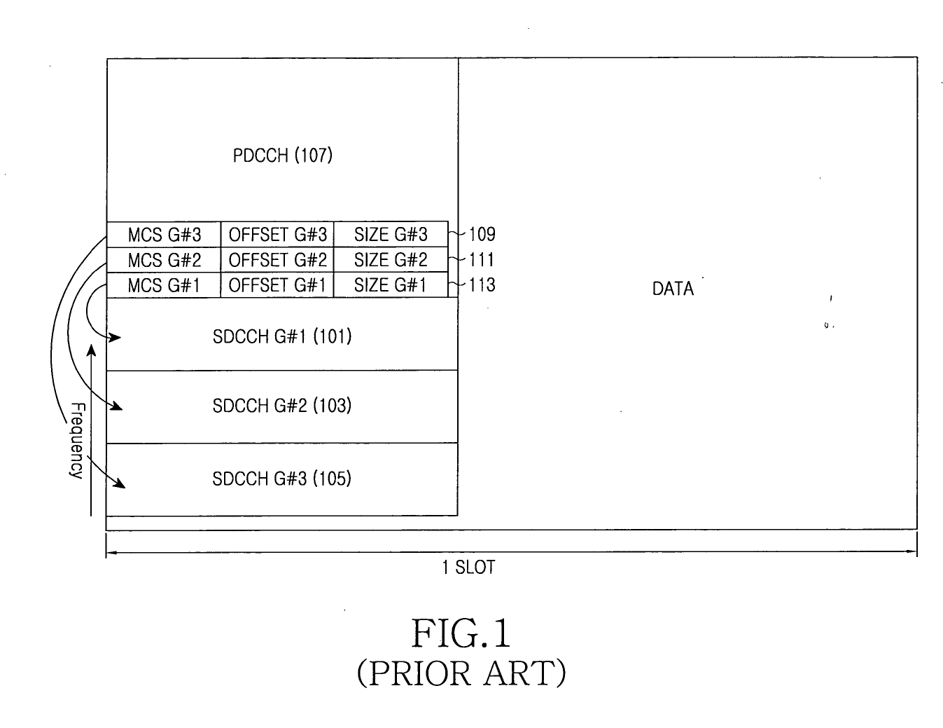

FIG. 2 is a diagram illustrating a transmission structure of control channels in a forward link of an OFDM system according to the present invention;

FIG. 3 is a block diagram of the structure of a transmission apparatus in an OFDM system according to the present invention;

FIG. 4 is a flow chart of a process of generating and transmitting control information of each group by a transmission apparatus in a forward link of an OFDM system according to the present invention;

FIG. 5 is a block diagram of the structure of a reception apparatus in an OFDM system according to the present invention; and

FIG. 6 is a flow chart of a process of receiving and demodulating control information of a corresponding group by a reception apparatus in a forward link of an OFDM system according to the present invention.

### DETAILED DESCRIPTION OF PREFERRED EMBODIMENTS

Exemplary embodiments of the present invention will now be described in detail with reference to the annexed drawings. In the following description, detailed description of known functions and configurations incorporated herein has been omitted for clarity and conciseness.

Although the number of groups of mobile terminals and SDCCHs is assumed herein to be 3 for convenience, the number of groups of SDCCHs can be extended to N.

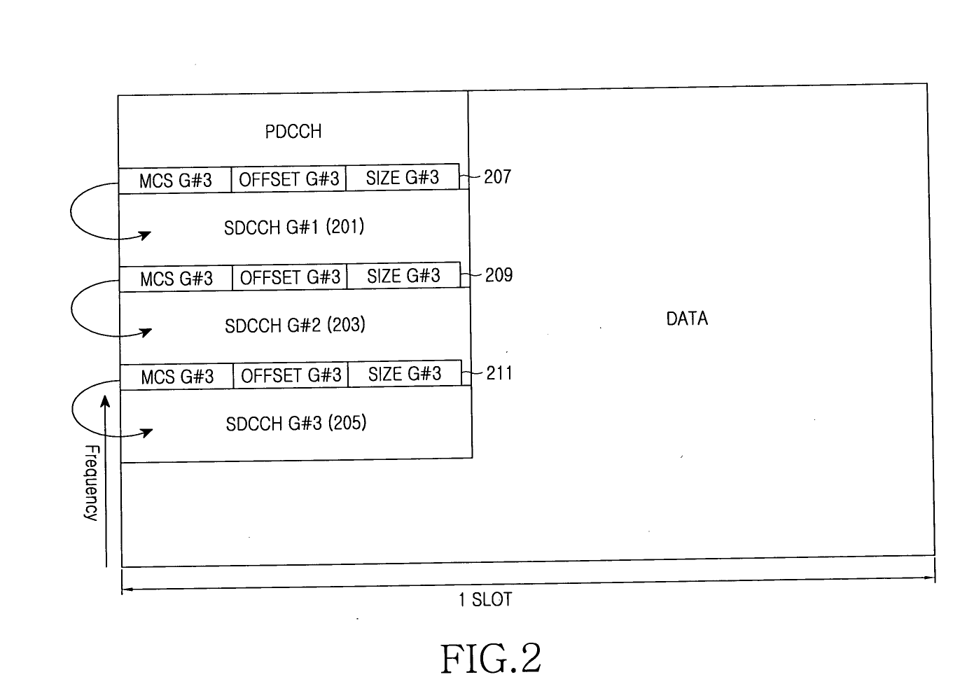

Referring to FIG. 2, this embodiment provides a proposed transmission structure of control channels by using PDCCH and SDCCH as control channels, and grouping the SDCCHs such that control information of each group is located in the PDCCH or the SDCCH of a preceding group in the link structure.

The SDCCHs are divided into, for example, 3 groups 201, 203 and 205 according to positions of mobile terminals in the cell and/or channel environments, and control information 207, 209 and 211 included in the PDCCH and the SDCCH of each group includes an MCS level of the next group, and position (i.e. offset of subcarrier) and size information of the SDCCH. Control information of a first SDCCH 201, which is a first group, is included in the PDCCH, which is a preceding control channel. Upon receiving the control information of the first group from the PDCCH, a mobile terminal demodulates first SDCCH 201 using the control information. Control information for demodulation of a second SDCCH 203, which is a second group, is included in preceding first SDCCH 201. The mobile terminal receives control information from first SDCCH 201 and demodulates second SDCCH 203 using the control information. In the same manner, control information for demodulation of a third SDCCH 205, which is a third group, is included in second SDCCH 203 of the preceding group. The mobile terminal receives the control information from second SDCCH 203, and demodulates third SDCCH 205 using the control information. In the course of demodulating the SDCCH of each group, the mobile terminal acquires control information of the SDCCH corresponding to its own Media Access Control (MAC) ID and its own group, and no longer demodulates SDCCHs of other groups.

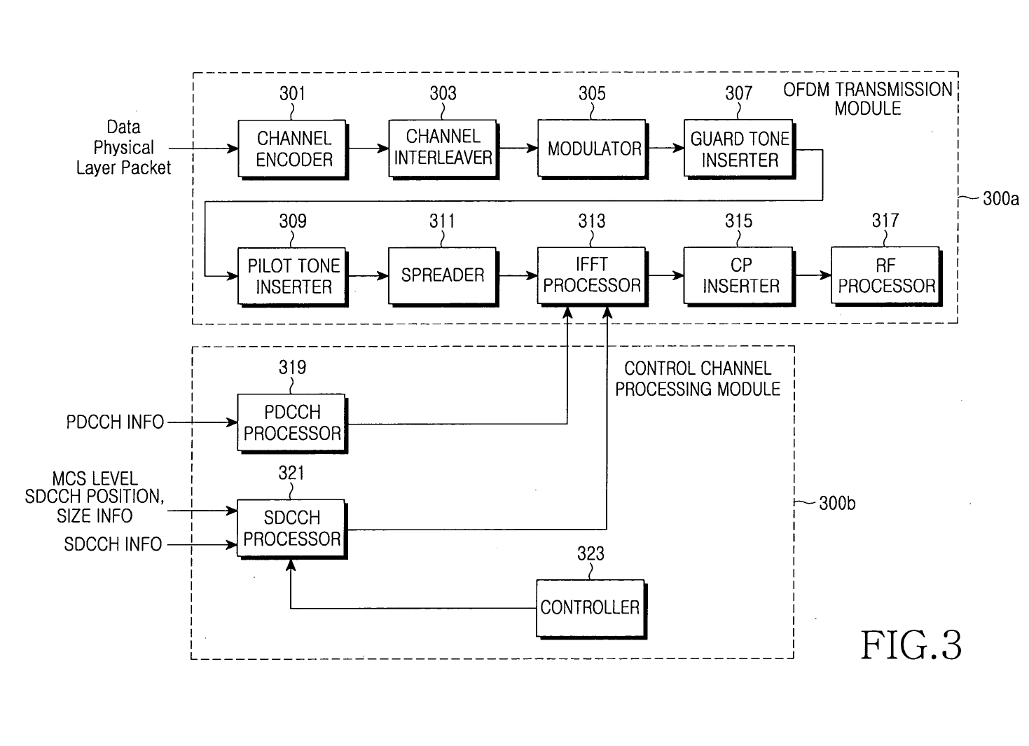

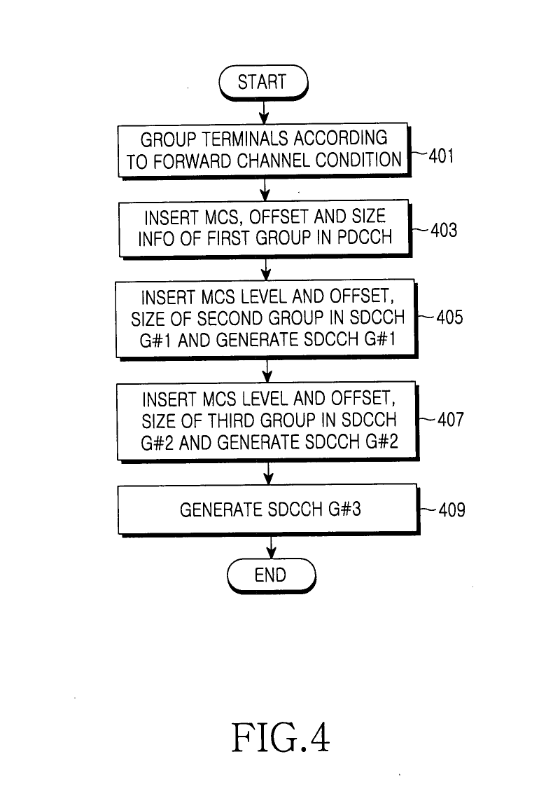

With reference to FIGS. 3 and 4, a description will now be made of a structure and operation of a transmission apparatus according to the present invention.

Referring to FIG. 3, in the transmission apparatus, an OFDM transmission module 300a generates an OFDM symbol by performing Inverse Fast Fourier Transform (IFFT) on packet data, and transmits to a wireless network the control information for demodulation of the SDCCH, provided from a control channel processing module 300b. The OFDM transmission module 300a includes a channel encoder 301 for channel-encoding packet data received from an undepicted physical layer, a channel interleaver 303 for interleaving the coded packet data, a modulator 305 for modulating the interleaved packet data, a guard tone inserter 307 for inserting guard tones for preventing an out-band signal from serving as interference, and a pilot tone inserter 309 for inserting pilot tones for channel estimation at a mobile terminal.

Further, the transmission apparatus includes a QPSK spreader 311, an IFFT processor 313 for transforming a time-domain signal into a frequency-domain signal, a Cyclic Prefix (CP) inserter 315 for inserting a CP in the front of OFDM data to prevent an interference signal, and a Radio Frequency (RF) processor 317 for converting the CP-inserted OFDM signal into an RF signal.

The control channel processing module 300b includes a PDCCH processor 319, an SDCCH processor 321, and a controller 323, and controls a generation and insertion operation for the control information. PDCCH processor 319 generates PDCCH information including control information such as MCS level for an SDCCH of the next group and position (offset of subcarrier) and size information of the SDCCH, connected in the link structure, and delivers the PDCCH information to the IFFT processor 313. Similarly, SDCCH processor 321 generates control information including MCS level for an SDCCH of the next group and position and size information of the SDCCH, connected in the link structure, and/or SDCCH information for demodulation of a data (traffic) channel in the current group, and delivers the generated information to the IFFT processor 313. Controller 323 controls an operation of inserting the control information generated from SDCCH processor 321 in the PDCCH or a corresponding position of the SDCCH before transmission.

Referring to FIG. 4, in step 401, a base station groups mobile terminals into a plurality of groups in association with SDCCHs according to positions of the mobile terminals and/or forward channel conditions. In this case, the base station can group the mobile terminals into a plurality of groups in order of a terminal with a lower Channel Quality Indicator (CQI) (for example, in order of a terminal located in the cell boundary to a terminal located in the cell center). It is assumed in FIG. 4 that the base station groups terminals and SDCCHs into 3 groups. In step 403, the base station generates control information including MCS level for a first SDCCH group among the 3 groups, and position (offset of subcarrier) and size information of the SDCCH, and inserts the control information in a PDCCH linked thereto. Similarly, in step 405, the base station generates control information including MCS level of a second SDCCH group, and position and size information of the SDCCH, and transmits the control information over the first SDCCH of the first group. In step 407, the base station generates control information including an MCS level of a third SDCCH group, and position and size information of the SDCCH, and transmits the control information over the second SDCCH of the second group. Finally, in step 409, the base station generates the third SDCCH according to a general operation because there is no next group.

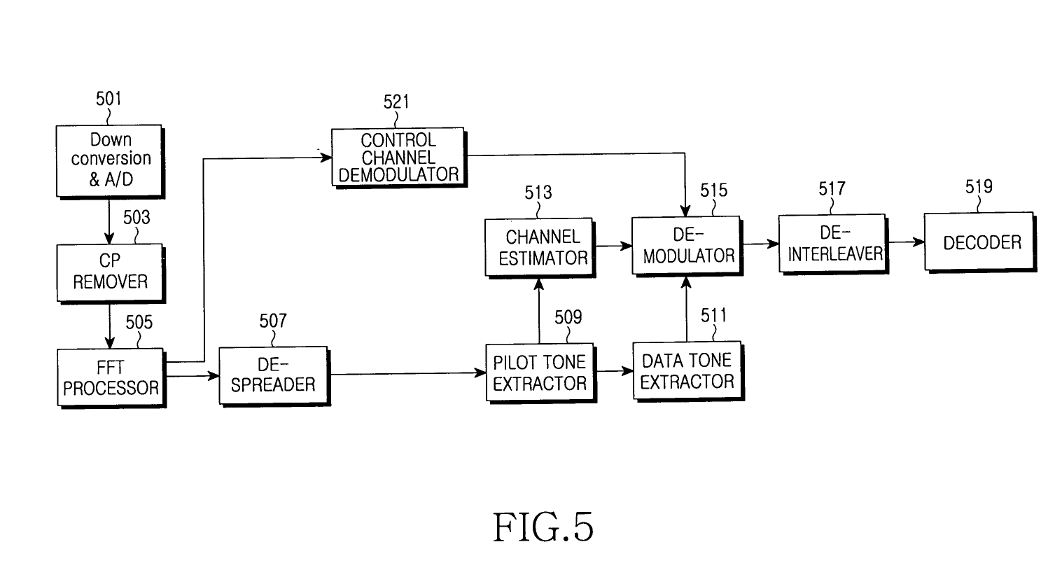

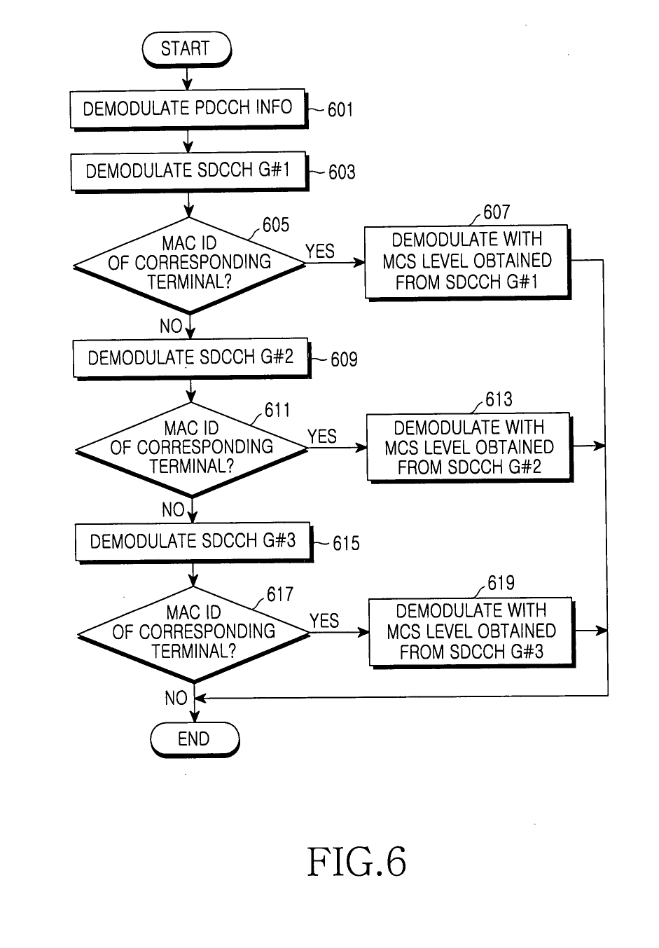

With reference to FIGS. 5 and 6, a description will now be made of a structure and operation of a reception apparatus according to the present invention.

Referring to FIG. 5, a down-conversion & analog-to-digital (A/D) conversion block 601 converts a signal received via a wireless network into a baseband signal, and converts the analog baseband signal into a digital signal. The digital signal is delivered to a CP remover 503, and the CP remover 503 removes from the received signal a CP contaminated due to propagation delay and multiple paths. A Fast Fourier Transform (FFT) processor 505 transforms an input time-domain signal into a frequency-domain signal, and a despreader 507 QPSK-despreads the frequency-domain signal and outputs tones of each signal, assuming that a QPSK-spread signal is transmitted from a transmission apparatus. Therefore, if the transmission apparatus uses a different spreading scheme, the reception apparatus also has a despreader supporting the corresponding spreading scheme.

Despreader 507 delivers the tones of the despread signal to a pilot tone extractor 509, which extracts pilot tones from the tones of each signal, delivers the extracted pilot tones to a channel estimator 513, and delivers the remaining signal tones to a data tone extractor 511. Data tone extractor 511 extracts data tones from the input signal tones, and sends the extracted data tones to a demodulator 515. Channel estimator 513 estimates a channel using the pilot tones, and delivers the channel estimated value to demodulator 515. Demodulator 515 performs demodulation on the data tones using the channel estimated value delivered from channel estimator 513, and the demodulated signal is deinterleaved by a deinterleaver 517 and then input to a decoder 519. Decoder 519 restores the transmitted signal by decoding the input signal.

A PDCCH/SDCCH signal, which has passed through FFT processor 505 in the foregoing reception process, is delivered to a control channel demodulator 521. Control channel demodulator 521 demodulates control information received from a control channel, i.e. PDCCH/SDCCH, and delivers the demodulated control information to demodulator 515. Demodulator 515 then demodulates not only the traffic channel but also the SDCCH using the control information received from the PDCCH/SDCCH.

Referring to FIG. 6, in step 601, a receiver of a mobile terminal receives PDCCH information including control information #1 for demodulation of an SDCCH of the next group, and then demodulates the PDCCH information. In step 603, the receiver demodulates an SDCCH of a first group using the control information #1 thereby acquiring SDCCH information of the corresponding group and also acquiring control information #2 for demodulating an SDCCH of a second group. In step 605, the receiver determines if a MAC ID detected from the demodulate SDCCH of the first group is identical to a MAC ID of the corresponding mobile terminal, and if the detected MAC ID is identical to the MAC ID of the corresponding mobile terminal, the receiver demodulates data tones of a traffic channel using the SDCCH information of the first group in step 607. If the detected MAC ID is not identical to the MAC ID of the corresponding mobile terminal in step 605, the receiver demodulates the SDCCH of the second group using control information #2 in step 609 thereby acquiring SDCCH information of the corresponding group and also acquiring control information #3 for demodulating an SDCCH of a third group.

In step 611, the receiver determines if a MAC ID detected from the demodulated SDCCH of the second group is identical to the MAC ID of the corresponding mobile terminal, and if the detected MAC ID is identical to the MAC ID of the corresponding mobile terminal, the receiver demodulates data tones of the traffic channel using the SDCCH information of the second group in step 613. However, if the detected MAC ID is not identical to the MAC ID of the corresponding mobile terminal in step 611, the receiver demodulates the SDCCH of the third group using control information #3 in step 615 thereby acquiring SDCCH information of the corresponding group. In step 617, the receiver determines if a MAC ID detected from the demodulated SDCCH of the third group is identical to the MAC ID of the corresponding mobile terminal, and if the detected MAC ID is identical to the MAC ID of the corresponding mobile terminal, the receiver demodulates data tones of the traffic channel using the SDCCH information of the third group in step 619.

As can be understood from the foregoing description, the present invention reduces the amount of control information for the SDCCHs, transmitted over the PDCCH in a forward link of the OFDM system, thereby facilitating efficient management of PDCCH/SDCCH control channels.

While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A transmission apparatus for transmitting a control channel in an Orthogonal Frequency Division Multiplexing (OFDM) system, the apparatus comprising:
a transmitter for modulating a data channel and a plurality of control channels into a radio signal according to a predetermined transmission scheme, and transmitting the radio signal to a wireless network; and
a control channel processor for controlling an operation of transmitting channel by channel control information for demodulation of each of the control channels over other control channels respectively.

2. The transmission apparatus of claim 1, wherein the control channels are transmitted with different modulation schemes.

3. The transmission apparatus of claim 1, wherein a controlling factor of the control channel processor, for dividing each of the control channels, includes a position of a mobile terminal in a cell.

4. The transmission apparatus of claim 2, wherein each of the control channels transmits the control information for demodulation of a next control channel and another control information for demodulation of the data channel

5. The transmission apparatus of claim 4, wherein the control information includes at least one of an MCS (Modulation Coding Scheme) level, position information and size information, for the next control channel.

6. A transmission method for transmitting a control channel in an Orthogonal Frequency Division Multiplexing (OFDM) system, the method comprising:
generating a plurality of control channels such that control information for demodulation of the plurality of control channels is distributed over information of other control channels respectively; and
modulating a data channel and the control channels into a radio signal according to a predetermined transmission scheme, and transmitting the radio signal to a wireless network.

7. The transmission method of claim 6, wherein the control channels are transmitted with different modulation schemes.

8. The transmission method of claim 6, wherein a controlling factor for dividing each of the control channels, includes a position of a mobile terminal in a cell.

9. The transmission method of claim 7, wherein each of the control channels transmits the control information for demodulation of a next control channel and another control information for demodulation of the data channel.

10. The transmission method of claim 9, wherein the control information includes at least one of an MCS (Modulation Coding Scheme) level, position information and size information, for the next control channel.

11. A reception apparatus for receiving a control channel in an Orthogonal Frequency Division Multiplexing (OFDM) system, the apparatus comprising:
a receiver for receiving a data channel and a plurality of control channels, transmitted via a wireless network, according to a predetermined transmission scheme; and
a control channel demodulator for extracting control information for demodulation of the control channels from other previously received control channels respectively, and performing the demodulation using the control information.

12. The reception apparatus of claim 11, wherein the control channels are transmitted with different modulation schemes.

13. The reception apparatus of claim 11, wherein a controlling factor used in a transmitter, for dividing each of the control channels, includes a position of a mobile terminal in a cell.

14. The reception apparatus of claim 16, wherein each of the control channel includes the control information for demodulation of a next control channel and another control information for demodulation of the data channel.

15. The reception apparatus of claim 14, wherein the control channel demodulator determines if a Media Access Control (MAC) identifier included in a corresponding control channel is identical to its own MAC identifier when demodulating the control channel of each group, and the receiver demodulates the data channel using information of the corresponding control channel if the MAC identifier is identical to its own MAC identifier.

16. The reception apparatus of claim 15, wherein the control channel demodulator demodulates a control channel of a next group if the MAC identifier is not identical to its own MAC identifier.

17. The reception apparatus of claim 14, wherein the control information includes at least one of an MCS (Modulation Coding Scheme) level, position information and size information, for a control channel of a next group.

18. A reception method for receiving a control channel in an Orthogonal Frequency Division Multiplexing (OFDM) system, the method comprising:
receiving a plurality of control channels transmitted via a wireless network; and
extracting control information for demodulation of the control channels from other previously received control channels respectively, and performing the demodulation using the control information.

19. The reception method of claim 18, wherein the control channels are transmitted with different modulation schemes.

20. The reception method of claim 18, wherein the control channel includes the control information for demodulation of a next control channel and another control information for demodulation of the data channel.

21. The reception method of claim 26, further comprising:
determining if a Media Access Control (MAC) identifier included in a corresponding control channel is identical to its own MAC identifier when demodulating the control channel of each group; and
demodulating a data channel using information of the corresponding control channel if the MAC identifier is identical to its own MAC identifier.

22. The reception method of claim 21, further comprising demodulating a control channel of a next group if the MAC identifier is not identical to its own MAC identifier.

23. The reception method of claim 18, wherein the control information includes at least one of an MCS (Modulation Coding Scheme) level, position information and size information, for a next control channel.
